(19) United States
(12) Patent Application Publication
(10) Pub. No.: US 2026/0366868 A1
(43) Pub. Date: Nov. 19, 2026

(54) DYNAMIC VEHICLE ATTITUDE MEASUREMENT DEVICE

(71) Applicant: Carlos Sebastian NERINI, Toyino (IT)

(72) Inventors: Carlos Sebastian NERINI, Torino (IT); Nicolas Agustin CARABETTA, Villa Centenario (AR); Federico RAPPAZZO, Buenos Aires (AR)

(21) Appl. No.: 19/132,090

(22) PCT Filed: Aug. 9, 2023
(86) PCT No.: PCT/IT2023/050195

§ 371 Date: May 22, 2025

(30) Foreign Application Priority Data
Nov. 25, 2022 (IT) 1022000024318

(51) Int. Cl. G01B 11/275

(52) U.S. Cl. CPC G01B 11/2755

(57) ABSTRACT

A device (100) is provided for dynamic measurement of the set-up of a vehicle with two, three, four or more wheels. The device (100), adapted to be fitted on a wheel (1) of said vehicle, comprises one or more contactless detection sensors (4), for measuring said set-up with respect to the plane defined by the ground(S). Said one or more sensors (4) define at least three detection axes not aligned with each other, determining a plane (T) which intersects the wheel (1) transversally and are integral with said plane (T) and with a longitudinal plane (L) passing through the center line of said wheel (1).

### FIELD OF THE INVENTION

This invention relates to devices and systems for measuring the set-up of a vehicle, in particular for measuring the alignment and orientation parameters of the wheels and suspensions with respect to the three Cartesian axes, as well as the height of the wheels with respect to the ground under load conditions.

### STATE OF THE ART

In the state of the art, devices and systems for measuring the set-up of a vehicle are well known.

In particular, as far as it is concerned, devices for measuring the orientation of the so-called “center plane” of a vehicle wheel with respect to the three Cartesian axes are known, i.e. of those alignment parameters, defined by the wheels and suspensions of the vehicle, which give to the latter a certain set-up and specific attitudes in driving behaviour, with direct repercussions on driving quality, safety, performance, consumption and, last but not least, the wear of the mechanical components.

Specifically, among the most relevant measurement parameters, one can list: the camber angle i.e., the angle between the vertical axis of a wheel and the vertical axis of the vehicle; caster (or castor) i.e., the angular displacement of the steering axis from the vertical axis; and toe i.e., the angle of the wheel with respect to the longitudinal axis of the vehicle. A further fundamental parameter is represented by the so-called wheel loaded radius i.e., the distance between the wheel hub and the ground under vehicle load conditions. The measurement of further parameters and physical quantities is also conceivable.

Now, the measurement of said parameters is generally performed under totally static conditions. In known measurement methods, the vehicle, inside a specialized mechanical workshop, is placed on a special platform and, by means of devices and detectors that can be installed on the wheels, the suspensions and the bodywork, such as, for example, laser rangefinders, gyroscopes, optical sensors and transducers, the aforementioned measurements are taken and then analyzed and processed by means of software.

U.S. Pat. No. 11, 466,981B2 illustrates a system for detecting the alignment of the wheels of a vehicle, including toe, camber and caster angles, comprising: a measuring device, equipped with a wireless transmitter; a portable remote device, equipped with a wireless receiver; a controller for signal processing; and a display screen. The measuring device comprises, for each side of the vehicle, a camera and/or an inclination sensor mounted on a wheel.

These devices have evident limitations and disadvantages linked to the measurement conditions themselves. Static type measurements, i.e. with the vehicle stationary and tied to the ground, in fact, do not allow for analysis of the actual wheel and suspension set-up as it occurs while the vehicle is in motion. Accelerations, braking, steering speeds, stresses, etc., greatly influence the distribution of weights, forces and the position of the vehicle's center of gravity, influencing the very geometry of the wheels, suspensions and tyres, the alignment of the mechanical components and deformations of materials.

In static conditions, these behaviors can only be simulated with inaccurate and unreliable calculation and integration methods.

CN103852268A discloses a system for measuring the kinematics of a vehicle's suspension under dynamic conditions. The system includes devices for measuring suspension and tire inclination, and wheel angles. The measurement takes place through gyroscopic devices connected to each other and associated with a data acquisition and processing device.

However, these measurements, based on gravitational analysis and carried out taking as reference not the plane defined by the ground, but the plane defined by the body or chassis of the vehicle, are associated with imprecise and inconsistent values.

Furthermore, devices and methods such as those described by CN110044270A intended for measuring the distance from the ground of a wheel of a vehicle or, again, systems for measuring the camber angle in dynamic conditions are known. These devices generally use laser rangefinders connected to data acquisition and processing devices.

However, these devices are not capable of providing, contextually and in dynamic conditions, all the quantities useful for defining the vehicle set-up as illustrated above.

### OBJECT OF THE INVENTION

An object of the present invention is, therefore, to provide a device which overcomes and avoids the main defects and the most serious constraints of the prior art.

In particular, a device is provided which is adapted to measure the main parameters which define the set-up of a vehicle in dynamic conditions, for example during road or track tests.

These measurements are carried out in a direct and contactless mode with respect to the road surface, by means of sensors integral with the wheel plane, with evident advantages in terms of utility and progress with respect to the prior art, accuracy and consistency of the measurements. In particular, the invention does not require the use of complex and imprecise calculation and simulation algorithms.

### SUMMARY THE INVENTION

These and other purposes are achieved with the device as described in the enclosed claims.

According to the present invention, a device for dynamic measurement of the set-up of a vehicle with two, three, four or more wheels is provided. The device, adapted to be fitted on a wheel of said vehicle, comprises one or more contactless detection sensors for measuring said set-up with respect to the plane defined by the ground.

In particular, the one or more sensors define at least three detection axes not aligned with each other, determining a plane which intersects the wheel transversally, wherein said one or more sensors are integral with said plane and to a longitudinal plane passing through the center line of said wheel.

According to a preferred embodiement, the device comprises a single sensor adapted to measure over at least three detection axes not aligned with each other. Alternatively, two detection sensors, wherein a first sensor is a sensor adapted to measure over two first detection axes and a second sensor is a sensor adapted to measure over one single second detection axis can be provided, wherein said second detection axis is not aligned to the two first detection axes. Alternatively, three sensors adapted to measure over single detection axes not aligned with each other.

Preferably, said one or more sensors are arranged on a structural element which can be fastened, anteriorly, to the rim of said wheel by means of a fastening element and/or, posteriorly, to the spindle of said wheel by means of a specific support. Alternatively, said one or more sensors are arranged on brackets which can be connected to the spindle of said wheel.

Advantageously, the device further comprises a wheel force and/or momentum transducer equipped with an electromechanical slip ring; said transducer being interposed between the structural element, if provided, and the rim.

Additional optical sensors, infrared temperature sensors, pressure sensors, accelerometers, gyroscopes, strain gauges, optical fiber and video sensors can be provided.

### BRIEF DESCRIPTION OF THE FIGURES

These and other advantages and characteristics of the present invention will become clear from the following description of preferred embodiments made by way of non-limiting example with reference to the accompanying drawings, in which:

FIG. 1A shows a front isometric view of a device for dynamic measurement of the set-up of a vehicle according to the invention in a three-sensor embodiement;

FIG. 1B shows a front isometric view of a device for dynamic measurement of the set-up of a vehicle according to the invention in a two-sensor embodiement;

FIG. 2 shows a front isometric view of the device of FIG. 1, in a first embodiement, installed on the wheel of a vehicle;

FIG. 3 shows a rear isometric view of the device of FIG. 1, in a first embodiment, installed on the wheel of a vehicle;

FIG. 4 shows a rear isometric view of the device of FIG. 1, in a second embodiment, installed on the wheel of a vehicle; and

FIG. 5 shows the view of FIG. 2 to which the longitudinal and transversal planes of the vehicle wheel and the plane defined by the ground have been added.

### DESCRIPTION OF PREFERRED EMBODIMENTS

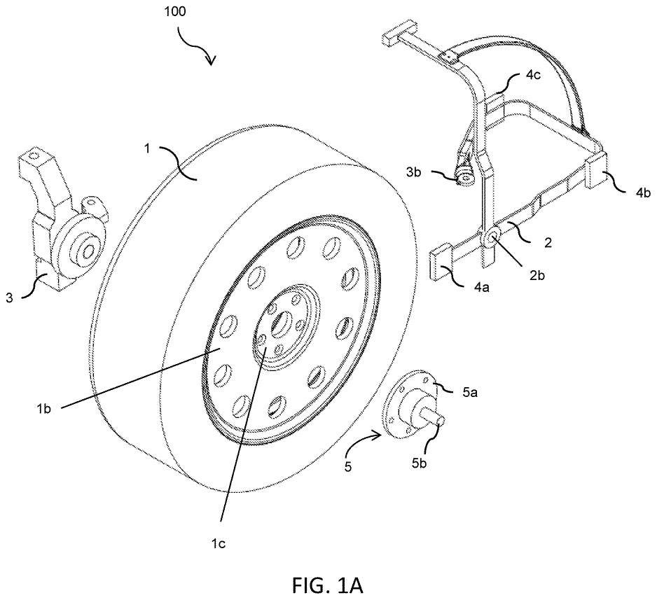

With reference to FIGS. 1-4, a device for dynamic measurement of the set-up of a vehicle 100 is provided.

In the present disclosure, the term “vehicle” is used to indicate any road vehicle with two, three, four or more wheels intended for the transport of passengers and/or goods. In particular, the invention will be applicable, with the exception of slight modifications and structural variations, and without departing from the scope of the invention, to motorcycles, quads, cars, vans and trucks. For purposes of convenience only, reference will preferably be made to four-wheeled passenger vehicles.

The term “set-up” refers to the series of angles and adjustments of the wheels, suspension group and tyres of a vehicle which define its behavior and performance on the road or on the track. In particular, in the present disclosure, as specified above, “set-up” refers to the orientation of the so-called “center plane” of the wheel of a vehicle with respect to the three Cartesian axes, i.e. the angles and alignment parameters, defined by vehicle wheels and suspension; including camber, caster and toe angles, the so-called wheel load radius, i.e. the distance between the wheel hub and the ground under vehicle load conditions, the kinematic steering axis of the wheel, all its derivations or, again, the dynamics of the tyres.

On the other hand, the term “dynamic measurement” refers to a measurement carried out in real conditions of use and running of the vehicle, in particular during acceleration, braking and steering, which, due to the induced stresses, greatly influence the distribution of weights, forces and the position of the center of gravity of the vehicle, as well as the same geometry and alignment of the components, and the deformations of the materials.

The device 100, adapted to be applied to a wheel 1 of a vehicle, comprises one or more contactless detection sensors 4, for measuring the set-up, as described above, with respect to the plane defined by the ground [S].

According to the invention, said one or more sensors 4 define at least three detection axes not aligned with each other, determining a plane [T] which intersects the wheel 1 transversely.

Further, according to the invention, said one or more sensors 4 are integral with said plane T and with a longitudinal plane L passing through the center line of said wheel 1.

The term “integral”, as known to those skilled in the art, means a rigid constraint with respect to a reference body. In this case, with the expressions “integral with planes [T] and [L]” it should be understood, by extension of the term, one or more sensors will be integrally connected to the “wheel group”, i.e., for example, to the spindle 3.

This measurement, as previously mentioned, has evident advantages in terms of utility and progress with respect to the known art, as well as in terms of accuracy and consistency of the measurements. Indeed, the possibility of measuring these parameters directly with respect to the ground and not with respect to the chassis or body of the vehicle avoids the onset of problems related to the reference system of the vehicle, as well as avoiding a subsequent processing of the data obtained by means of complex and imprecise calculation and simulation algorithms.

In other words, it will be measured the plane [T] of the wheel 1 with respect to the ground plane [S] and not an imaginary plane passing through further elements of the car subject to deformations, misalignments and, consequently, linked to inaccuracies in the measurement.

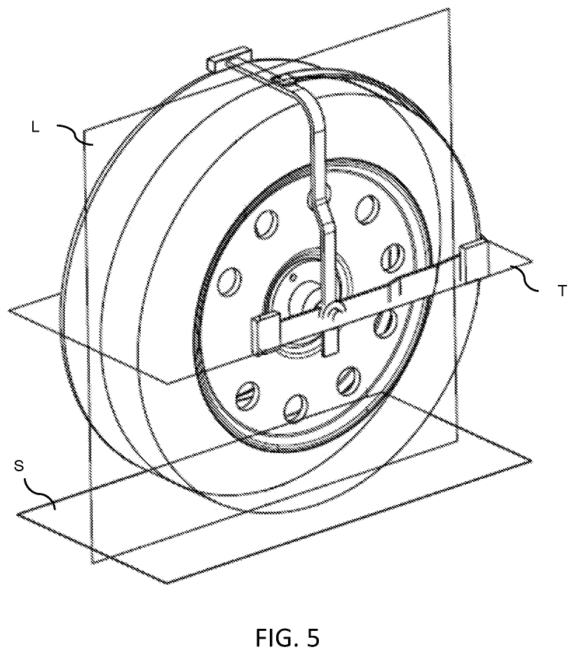

With reference to FIG. 5, [S], [T] and [L] respectively indicate the plane defined by the ground, the transverse plane to the wheel 1 and the longitudinal plane passing through the center line of said wheel 1.

Now, the presence of one or more sensors 4 which define at least three detection axes allows the definition of the plane [T], from which the definition of the plane [L] can be directly obtained. From the relative orientation of these two planes [T, L] with respect to the ground, measured by instantaneous distance from the plane [S], it is possible to obtain, directly and accurately, all the parameters which define the set-up of a vehicle as here intended.

The devices of the prior art, on the other hand, generally provided with only two measuring points, lacking the possibility of triangulating the distances, are not able to provide such measurements. Moreover, the known devices are not integral with the wheel and are provided with at least a degree of freedom associated with the abovementioned drawbacks.

According to a preferred embodiment of the invention, the device 100 comprises a single sensor 4 adapted to measure over at least three detection axes not aligned with each other.

The term “detection axes”, in the present disclosure do not refers to Cartesian or coordinated axes, but to axes defined by design choices, such as to allow the definition of the transversal plane [T] of the wheel 1. Said axes will not be among them necessarily orthogonal.

Equally preferably, the device 100 can be provided with two detection sensors 4a; 4b, wherein a first sensor 4a is a sensor adapted to measure over two first detection axes and a second sensor (4b) is a sensor adapted to measure over one single second detection axis, also known as a “spot” sensor. According to the invention, said second detection axis is not aligned to the two first detection axes.

Alternatively, three sensors 4a; 4b; 4c adapted to measure over single detection axes not aligned with each other (spot sensors) can be provided.

It is evident to the skilled person that, in some embodiments, a number of sensors 4 greater than three, for example four or five sensors, may be provided without departing from the scope of the invention.

Preferably, said one or more sensors 4 are optical sensors. However, other types of contactless sensors can be implemented, in particular, but not only, infrared sensors, ultrasonic sensors, scanners, etc.

In a preferred embodiment of the invention, the device 100 is provided with a structural element 2 on which said one or more sensors 4 can be arranged.

The term “structural element” refers to a structure or frame configured to support the components of the present invention, in particular all the sensors as described above and below.

For example, as illustrated in FIGS. 1A and 1B, respectively illustrating an embodiement with three sensors 4a; 4b; and 4c and an embodiment with two sensors 4a and 4b, said structural element 2 can be fastened, anteriorly, to the rim (1b) of said wheel 1 by means of a fastening element 5. Alternatively or in addition, a constraint to the spindle (3) of said wheel (1) by means of a specific support (3b) can be provided posteriorly.

It is evident to the person skilled in the art that design variations in the geometry and arrangement of the structural element 2, in the number and in the location of the fixing points of said element 2 to the wheel 1, could be envisaged on the basis of the type of vehicle on which the device 100 is installed, the dimensions of the wheel 1, the space available, the geometry of the spindle 3, etc.

In particular, the structural element 2 can be designed as a modular element and/or equipped with adjustable or retractable components or, again, with variable geometry and dimensions, so as to be able to be adapted to the vehicle specifications.

In a preferred embodiment illustrated in FIG. 1A, a first optical sensor 4a and a second optical sensor 4b can be placed on a first arm of the structural element 2 arranged in front of the wheel 1 and longitudinally with respect to the direction of motion of the vehicle. A third optical sensor 4c, on the other hand, can be placed on a second arm of the structural element 2 arranged behind the wheel 1 and in an opposite position to the second optical sensor 4b.

In a second preferred embodiment illustrated in FIG. 1B, a first optical sensor 4a can be placed on a first arm of the structural element 2 arranged in front of the wheel 1 and longitudinally with respect to the direction of motion of the vehicle, while a second optical sensor 4b can be placed on a second arm of the structural element 2 arranged behind the wheel 1 and in an opposite position to the second optical sensor 4b.

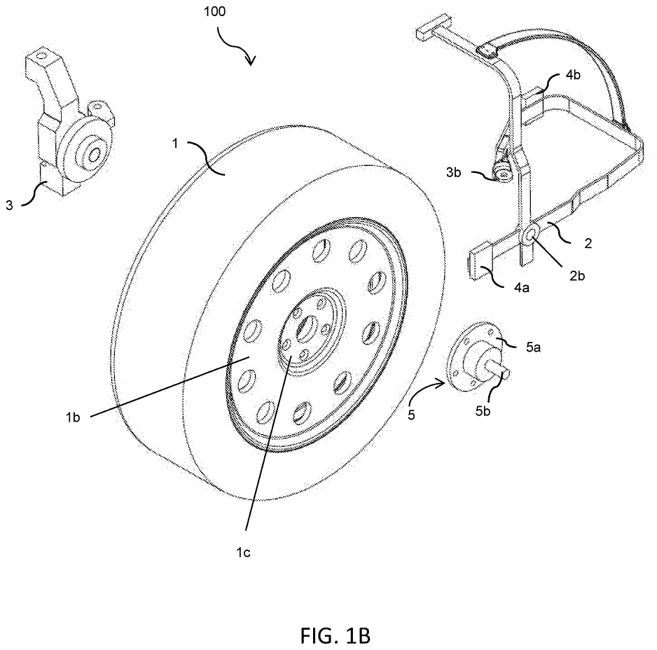

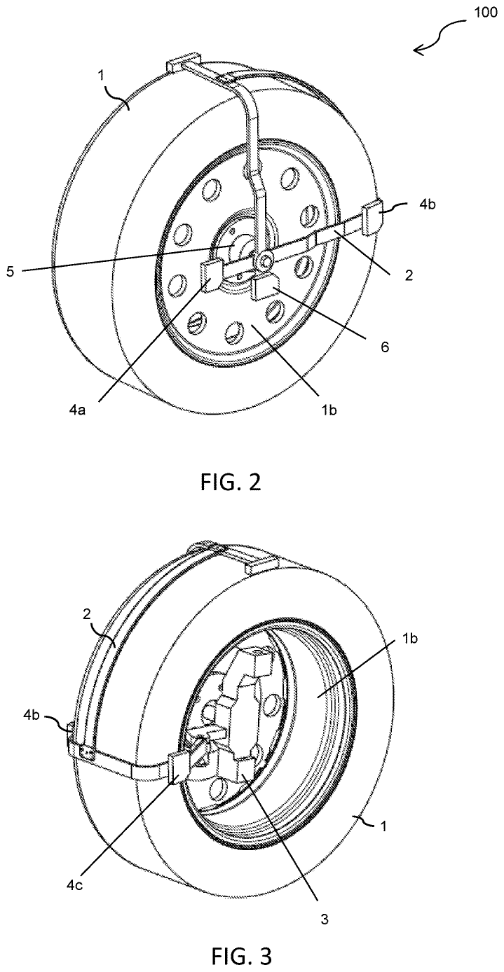

FIGS. 2 and 3 show a device 100, in a preferred embodiment, installed on a wheel 1 of a vehicle.

As anticipated, the device 100 provides a fastening element 5 able to connect the structural element 2 to the wheel 1 of the vehicle. Preferably, the fastening element 5 comprises a flange 5a, for example of metallic material, suitable for adapting to a suitable seat 1c formed in the rim 1b and a connection element 5b, for example a pin, suitable for engaging in a seat 2b of the structural element 2.

To ensure the presence of a degree of freedom between said structural element 2 and wheel 1, i.e. to ensure that the latter can rotate freely without dragging the entire device 100, a mechanical bearing is provided inside said seat 2b.

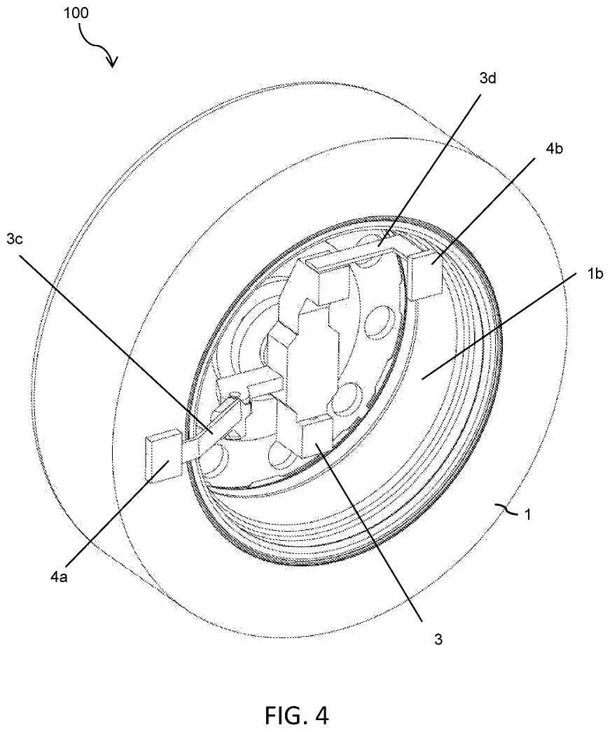

In a further preferred embodiment illustrated in FIG. 4, said one or more sensors 4 can be arranged on suitable brackets 3c; 3d which can be connected to the spindle 3 of said wheel 1.

It is clear to the skilled person that the location of said one or more sensors 4 will significantly depend on the geometries of the vehicle on which the device 100 is installed and that alternative configurations and arrangements to those described will be possible without departing from the scope of the present invention.

Additionally, the device 100 according to the invention may comprise a force and/or momentum transducer. This element, known in the state of the art, is configured, thanks to the presence of an electromechanical slip ring, to measure the forces and momentum produced by the wheel, transferring them from a rotating body to a fixed one below form of electromagnetic or electrical signals.

In the embodiment described above, for example, said force and/or momentum transducer, not shown in the figures, can be placed between the structural element 2 and the wheel rim 1b.

In addition, the device 100 according to the invention can comprise a two-axis optical sensor 6 placed on the structural element 2. Said sensor is useful, for example, for measuring distances, accelerations, angular speeds of rotation of the wheels, as well as the so called slip angles of the tire.

Finally, the device 100 is configured to cooperate, and possibly integrate, with other traditional sensors and measurement systems such as, purely by way of example, dynamometric wheels, infrared temperature, pressure, acceleration sensors, gyroscopes, strain gauges, fiber optic sensors and video sensors.

The data produced by the device 100 according to the invention can be acquired and processed by means of suitable electronic and/or IT devices and calculation algorithms, as well as can be analyzed by means of a PC.

It is evident that what is described is given only as a non-limiting example £ and that variations and modifications are possible to the expert without departing from the scope of the invention, as defined by the following claims.

For example, design variations in the geometry and in the arrangement of the structural element 2 and of the fastening element 5, as well as their attachment points to the wheel 1 will have to be envisaged based on the type of vehicle on which the device 100 is installed, the dimensions of said wheel 1, the available space, the geometry of the hub carrier 3, etc.

The device 100 according to the invention is configured to provide a precise measurement of the main quantities and parameters which define the set-up of a vehicle and, along with it, its behavior on the road. The possibility of carrying out measurements on the orientation of wheels and suspensions in dynamic conditions, by means of sensors integral with the wheel plane, of measuring the distance from the ground of the wheel hub under load, of analyzing the dynamics of the tyres and of having at least three measurement points not aligned with each other for the triangulation allows to obtain an accurate and consistent analysis of the kinematics and dynamics of the vehicle.

1-11. (canceled)

12. A device for dynamic measurement of a set-up of a vehicle with two or more wheels, the device adapted to be fitted on one of the wheels of the vehicle,
wherein the device comprises one or more contactless detection sensors for measuring the set-up with respect to a ground plane defined by the ground,
wherein the one or more sensors define at least three detection axes not aligned with each other,
wherein a plane intersects the wheel transversally and the one or more sensors are integral with the plane and with a longitudinal plane passing through a center line of the wheel.

13. The device according to claim 12, wherein the one or more sensors comprises a single sensor adapted to measure over at least three detection axes not aligned with each other.

14. The device according to claim 12, wherein the one or more sensors comprises two detection sensors, wherein a first sensor is a sensor adapted to measure over two first detection axes and a second sensor is a sensor adapted to measure over one single second detection axis, wherein the second detection axis is not aligned to the two first detection axes.

15. The device according to claim 12, wherein the one or more sensors comprises three sensors adapted to measure over single detection axes not aligned with each other.

16. The device according to claim 12, wherein the one or more sensors are arranged on a structural element, and wherein the structural element is configured to be fastened, anteriorly, to a rim of the wheel by a fastening element.

17. The device according to claim 12, wherein the one or more sensors are arranged on a structural element, and wherein the structural element is configured to be fastened, posteriorly, to a spindle of the wheel by a support.

18. The device according to claim 12, wherein the one or more sensors are arranged on brackets, and wherein the brackets are configured to be connected to a spindle of the wheel.

19. The device according to claim 12, wherein the one or more sensors are optical sensors.

20. The device according to claim 12, further comprising a wheel force or momentum transducer equipped with an electromechanical slip ring, wherein the transducer is interposed between a structural element and a rim of the wheel.

21. The device according to claim 12, further comprising a two-axis optical sensor placed on a structural element.

22. The device according to claim 12, further comprising infrared temperature sensors, pressure sensors, accelerometers, gyroscopes, strain gauges, optical fiber and video sensors.

23. The device according to claim 12, further comprising an electronic or computer device for acquiring and processing data.
